(19) United States
(12) Patent Application Publication
(10) Pub. No.: US 2025/0078838 A1
(43) Pub. Date: Mar. 6, 2025

(54) AIRCRAFT PILOTING ASSISTANCE METHOD

(71) Applicant: THALES, MEUDON (FR)

(72) Inventors: Sylvain YAN, TOULOUSE (FR); Fany BARAILLER, TOULOUSE (FR); Arona GAYE, TOULOUSE (FR); François HOOFD, TOULOUSE (FR)

(21) Appl. No.: 18/824,807

(22) Filed: Sep. 4, 2024

(30) Foreign Application Priority Data
Sep. 6, 2023 (FR) 2309374

(51) Int. Cl. G10L 15/26; G10L 15/08; G10L 15/22

(52) U.S. Cl. CPC G10L 15/26; G10L 15/08; G10L 15/22; G10L 2015/223

(57) ABSTRACT

An aircraft piloting assistance method, including the following steps implemented by an electronic piloting assistance device: detecting an event, with said event being an event for identifying a note class from among a set of predefined events for identifying N note classes, with N being an integer≥2; following the detecting step, triggering the acquisition of a voice signal currently being transmitted or received by the pilot and associated with the note class, and processing the acquired voice signal, with the processing being a function of the note class and comprising at least the conversion of the voice signal into text and the generation of a note as a function of the text.

### CROSS-REFERENCE TO RELATED APPLICATION

This application claims priority to foreign French patent application No. FR 2309374, filed on Sep. 6, 2023, the disclosure of which is incorporated by reference in its entirety.

### FIELD OF THE INVENTION

The invention is in the field of assistance for piloting a civil or military aircraft.

### BACKGROUND

Currently, in an aircraft, the pilot (or more generally a member of the crew) uses a flight log, a notebook or a sheet of paper using a pen to note the information they consider to be important, to retain for future use, during the flight or after the flight. The pilot or the crew can also use a touch-sensitive digital interface (or “EFB” (Electronic Flight Bag)) for the same purpose, using the keyboard as an input mode.

However, these two solutions do not allow any notes to be made when their hands are occupied. Furthermore, this note-taking is time consuming and dominates the attention of the pilot.

Therefore, a requirement exists to provide note-taking that does not have these disadvantages.

### SUMMARY OF THE INVENTION

To this end, according to a first aspect, the present invention describes an aircraft piloting assistance method, comprising the following steps implemented by an electronic piloting assistance device:
detecting an event, with said event being an event for identifying a note class from among a set of predefined events for identifying N note classes, with N being an integer≥2;
following said detecting step, triggering the acquisition of a voice signal currently being transmitted or received by the pilot and associated with said note class, and processing said acquired voice signal, with said processing being a function of the note class and comprising at least the conversion of the voice signal into text and the generation of a note as a function of the text.

The method according to the invention thus fulfills some existing written note-taking tasks that are currently the responsibility of the pilot.

The proposed solution involves a system for capturing and interpreting the voice (of the pilot, of a control tower officer, etc.) in different modes, for storing the provided information and for displaying it on a screen for future use. These notes are determined by transcribing the voice and are presented to the pilot in a clear and unambiguous manner.

The solution meets the requirement for noting information to be remembered and for future use (for short-term consultation, in the minutes after taking the notes, or for consultation during the flight or even for consultation after the flight). It thus frees up time and attention resources that the pilot previously dedicated to these tasks and also even allows them to be performed when the pilot is occupied with other tasks. This is particularly valuable for difficult piloting phases, and even more so in the case of single-pilot crews or during flight phases requiring the most note-taking: on the ground before take-off and in flight when preparing the approach phase.

In embodiments of the invention, such a method will further comprise at least one of the following features:

detecting that an event for identifying a note class is a function of at least one element from among the following: detecting a keyword in a voice signal currently being transmitted or received by the pilot, detecting the manual or virtual activation of a Human Machine Interface element in the aircraft;

the signal to be acquired and processed is selected as a function of the note class identified by the detected identification event;

the aircraft piloting assistance method comprises at least one of the features from among:

i/ an identification event that has been predefined in order to identify the transmission of a voice signal by the pilot via their microphone to the control tower, with the acquisition and the processing following the detection of such an event in this case being selectively carried out on the voice signal transmitted by the pilot;

ii/ an identification event that has been predefined in order to identify the broadcasting of an ATIS recording in the aircraft to the pilot, with the acquisition and the processing following the detection of such an event in this case being selectively carried out on the voice signal received by the pilot;

iii/ an identification event that has been predefined in order to identify a voice note command triggered by the pilot, with the acquisition and the processing following the detection of such an event in this case being selectively carried out on the voice signal transmitted by the pilot;

the aircraft piloting assistance method comprises at least one of the following provisions:

in the case of feature i: detecting the identification event comprises detecting the activation of the Push-To-Talk button by the pilot;

in the case of feature i or iii: detecting the identification event comprises detecting a keyword in a voice signal transmitted by the pilot or detecting the selection of a Human Machine Interface element by the pilot;

in the case of feature ii: detecting the identification event comprises detecting a keyword in a voice signal received by the pilot or detecting the selection of a Human Machine Interface element by the pilot;

said processing comprises one or more steps selected as a function of the type of note class from among the following: raw transcription of the voice signal, selective extraction of data from the text that relates to the flight parameters, determining a summary of the text.

According to another aspect, the invention describes a computer program intended to be stored in the memory of an aircraft piloting assistance device and further comprising a microcomputer, said computer program comprising instructions which, when executed on the microcomputer, implement the steps of a method according to the first aspect of the invention.

The invention also describes a non-transient computer-readable medium storing such a computer program.

According to another aspect, the invention describes an aircraft piloting assistance device, said device being adapted for detecting an event, with said event being an event for identifying a note class from among a set of predefined events for identifying N note classes, with N being an integer≥2;

said device being further adapted, following said detecting step, for triggering the acquisition of a voice signal currently being transmitted or received by the pilot and associated with said note class and for processing said acquired voice signal, with said processing being a function of the note class and comprising at least the conversion of the voice signal into text and the generation of a note as a function of the text.

In embodiments of the invention, such a device will further comprise at least one of the following features:

detecting that an event for identifying a note class is a function of at least one element from among the following: detecting a keyword in a voice signal currently being transmitted or received by the pilot, detecting the manual or virtual activation of a Human Machine Interface element in the aircraft;

the aircraft piloting assistance device is adapted for selecting the signal to be acquired and processed as a function of the note class identified by the detected identification event.

### BRIEF DESCRIPTION OF THE DRAWINGS

The invention will be better understood, and further features, details and advantages will become more clearly apparent, from the following description, which is provided by way of non-limiting example, and by means of the appended figures, which are provided by way of example.

FIG. 1 is an illustration of a piloting assistance device according to one embodiment of the invention;

FIG. 2 shows the steps of a piloting assistance method according to one embodiment of the invention;

FIG. 3 is an example of an ATIS type note generated according to one embodiment of the invention;

FIG. 4 is an example of an ATC type note generated according to one embodiment of the invention;

FIG. 5 is an example of a “Miscellaneous” type note generated according to one embodiment of the invention.

Identical reference signs can be used in different figures when they designate identical or comparable elements.

### DETAILED DESCRIPTION

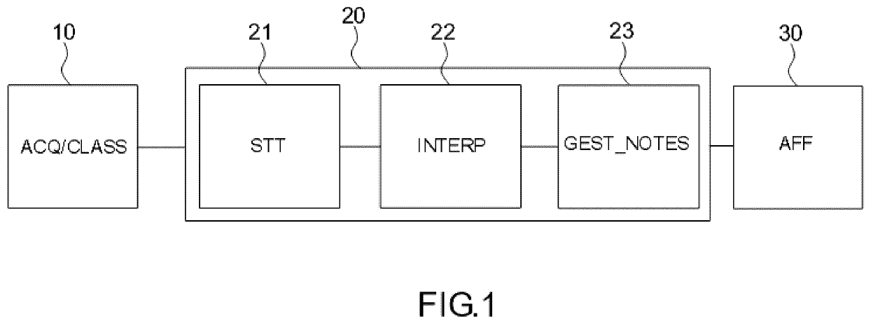

FIG. 1 is an illustration of a piloting assistance device 1 according to one embodiment of the invention, hereafter called assistance device 1, on board an aircraft (not shown).

In one embodiment, the assistance device 1 comprises an acquisition and classification unit 10, called ACQ/CLASS unit, a processing unit 20 and a display unit 30, called AFF unit.

The ACQ/CLASS unit 10 is adapted to acquire various types of voice signals and to assign a note class to them from among a plurality of predefined text note classes and to supply the processing unit 20 with the acquired voice signals associated with their class.

For example, the voice signals occurring in the cockpit notably include the following voice signals: ATC (“Air Traffic Controller”) signals, ATIS voice signals and various other voice signals.

ATC voice signals are the exchanges between the pilot and the control tower. Notably, when the aircraft pilot wishes to provide the ATC with voice information, the pilot presses a button, called Push-To-Talk button, located, for example, on their headset or control column or on the instrument panel of the aircraft, in order to switch from reception mode to transmission mode over a predefined half-duplex HF (“High Frequency”) or VHF (“Very High Frequency”) link and to vocally exchange the desired information.

ATIS (“Automatic Terminal Information Service”) is an automatic broadcasting service that allows pilots to continuously receive information in the aircraft that relates to the busiest airports.

ATIS voice messages, for example, are broadcast by an answering machine over a predefined radio frequency, called ATIS frequency, and contain essential information, such as meteorological data, the one or more runways in use, the available approach and any other information required by the pilots. Pilots generally listen to the ATIS via their headphones or loudspeakers in the cockpit before contacting the control tower, which reduces the workload of the controllers and reduces the time the frequency is occupied.

For example, in the case that is considered by way of an example, the ACQ/CLASS unit 10 is adapted to receive the following voice signals as input that are transmitted in the cockpit, or to receive at least some of them: for example, those transmitted by the pilot (for example, the microphone worn by the pilot comprises an output connected to an input of the ACQ/CLASS unit 10) and those transmitted to the pilot (at least some of the loudspeakers in the cockpit comprise an output connected to a respective input of the ACQ/CLASS unit 10, the audio headphones worn by the pilot comprise an output connected to a respective input of the ACQ/CLASS unit 10).

In the embodiment described herein, solely by way of illustration, the information to be noted has been considered to be of N=3 distinct types, listed below:
ATC type notes: radio communications carried out over VHF and HF frequencies for exchanges with ATC, in the Pilot-to-Control Tower direction;
ATIS type notes: ATIS information;
“Miscellaneous” type notes: miscellaneous notes “at the request” of the pilot.

For the first two types of notes (ATC and ATIS), in the considered embodiment, the information provided in the voice signal must be integrated into a note and the key information must be highlighted.

The miscellaneous notes, at the request of the pilot, notably relate, for example, to the following:
flight time monitoring: “block time”, “Take Off time”, “landing time”, “flight time”, etc.;
departure, arrival and taxiing information (for example, parking at the destination);
fuel management (for example, fuel quantity records): block at a given time, fuel flow, fuel used;
potentially, information after becoming aware of weather information (METAR/TAF), NOTAMs, airport information sheets, or information from listening to ATIS audio (for example: QNH, wind (speed and direction), runway in use).

The processing unit 20 is adapted to generate text notes: it is notably adapted to transpose a voice signal into a text note that has been classified by the ACQ/CLASS unit according to the class that has been assigned thereto. In the considered embodiment, the processing unit 20 comprises a voice-to-text transposition sub-unit 21, called STT (Speech-To-Text) unit, an interpretation unit 22, called INTERP (for example, a natural language processing and natural language understanding (NLP/NLU) component), and a note management sub-unit 23, called GEST_NOTES unit.

The AFF unit 30 is adapted to display the text notes generated by the processing unit 20 and comprises an HMI (Human Machine Interface) with, for example, a screen and a keyboard (or a touchscreen).

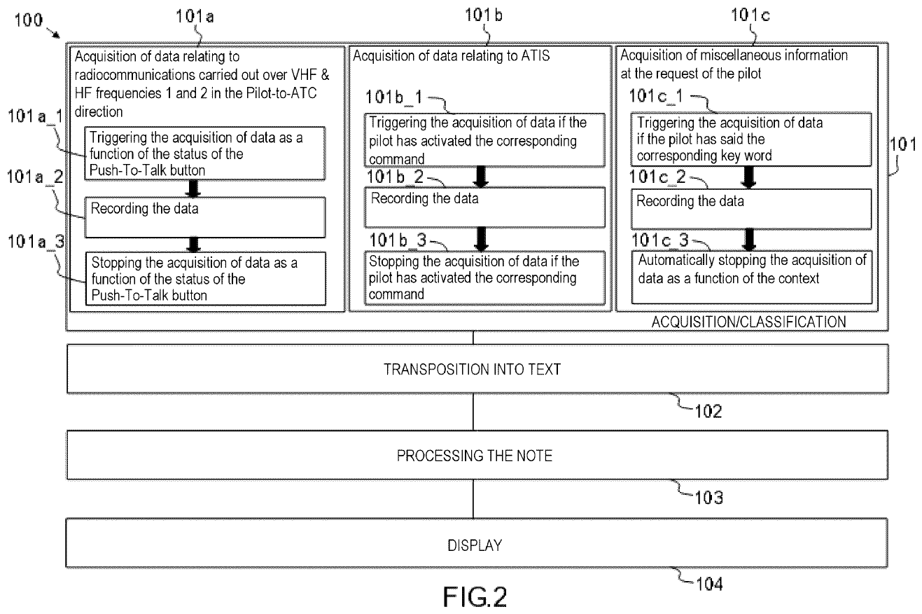

The assistance device 1 is adapted, in the considered embodiment, to implement the steps, shown in FIG. 2, of an aircraft piloting assistance method 100. The units that make up the device are thus adapted to implement the steps of the aircraft piloting assistance method 100 involving them. In one embodiment, the steps, or at least some of these steps, are implemented by executing, on a processor of the assistance device 1, software instructions stored in a memory of said assistance device 1.

The method 100 comprises a step 101 of acquiring and classifying voice signals, carried out by the ACQ/CLASS unit 10, which, during the various stages of the flight of the aircraft, receives the voice signals transmitted by the pilot and the signals received by the pilot as input, as described above.

The ACQ/CLASS unit 10 detects an event for identifying a class from among a predefined set of events for identifying N classes of text notes and, following this detection, triggers the acquisition of a voice signal and associates this voice signal with the class corresponding to this identification event.

The element for identifying a predefined class can be varied:
activating a specific HMI button (this is understood to mean activating a hardware button or selecting a field on a screen, of the cockpit, for example, that is associated with a predefined function); and/or
one or more key words spoken in a voice signal; and/or
the source of a voice signal (for example, pilot headset microphone or pilot headset earpiece); and/or
the flight phase (take-off, cruising, landing).

The ACQ/CLASS unit 10 clearly includes technical means allowing it to carry out this detection (voice recognition on the voice signals originating from the various gathered sources, detection of HMI button activation, etc.). In one embodiment, it is connected to one or more remote control units that carry out this detection and notify the ACQ/CLASS unit 10 in real-time.

The start and end of acquisition are defined for each note type.

Thus, in one embodiment, in a step 101a, as soon as the pilot is detected (step 101a_1) as having initiated a communication over an HF or VHF channel to the control tower (for example, by detecting a Push-To-Talk button in the cockpit or detecting a dedicated selection element on the HMI for selecting the radio transmission channel and that is used by the pilot), the ACQ/CLASS unit 10 begins to acquire the voice signal transmitted by the pilot (corresponding, for example, to the signal output from the pilot headset microphone): following this detection, the voice signal is recorded and also associated with the “ATC” class by the ACQ/CLASS unit 10 (step 101a_2). The acquisition of the audio stream is stopped (step 101a_3) when the pilot is detected as having ended the communication to the control tower by selecting one of the means for stopping the transmission (if the PTT (Push-To-Talk) button was previously selected, releasing or using a dedicated selection means on the HMI for selecting the radio transmission channel).

For example, in one embodiment, in a step 101b, as soon as an ATIS recording is detected (step 101b_1) as being broadcast (for example, by detecting a predefined keyword spoken at the start of an ATIS recording or detecting the activation of a Push button type selection button by the pilot (single press) or a Push-To-Note type button (button to be held down while listening to the ATIS) etc., depending on the selected configuration), the ACQ/CLASS unit 10 begins acquiring the broadcast voice signal (i.e., for example, the signal output from the headphones of the pilot headset or from a cockpit loudspeaker): it records the voice signal and also associates it with the “ATIS” class (step 101b_2). The acquisition of the audio stream is stopped (step 101b_3) when the end of the ATIS broadcast is detected (similarly by again detecting a predefined keyword spoken at the end of the ATIS recording or detecting the pilot activating or releasing a button or detecting a silence lasting longer than a predefined threshold X in the signal supplied as input to the headphones/loudspeaker (for example, X is equal to or greater than 300 ms), etc., depending on the selected configuration).

In one embodiment, in a step 101c, as soon as the pilot is detected (step 101c_1) as commanding Miscellaneous type note-taking (for example, by detecting a dedicated predefined key-word spoken by the pilot or by detecting the pilot activating a Push button (single press) type selection button or a Push-To-Note type button (button to be held down while the pilot states their voice message), etc., depending on the selected configuration), the ACQ/CLASS unit 10 begins acquiring the voice signal (i.e., for example, the signal output from the pilot headset microphone) by recording the voice signal and also associates it with the “Miscellaneous” class (step 101c_2). The acquisition of the audio stream is stopped (step 101c_3) when the end of the signal to be converted into a “Miscellaneous” type note is detected (for example, by detecting a predefined spoken keyword or by detecting the pilot activating or releasing a button or by detecting a silence lasting longer than a predefined threshold in the signal supplied as input to the microphone, etc., depending on the selected configuration).

In a step 102, any voice signal acquired in step 101 with its associated class is delivered by the ACQ/CLASS unit to the STT unit 21, which transposes it into text.

The STT unit 21 performs a level 0 text transcription (in the considered example corresponding to the raw text) involving a simple text transcription of what has been said. This raw text with the associated note class is then delivered to the INTERP unit 22, which performs initial formatting and thus delivers a level 1 text transcription of the voice signal. In the embodiment, the level 0 text transcription will only be available/consultable, for example, retrospectively, in the file for notes recorded during a flight. The raw text will not be displayed in step 104, but is stored in a memory of the assistance device 1 in association with the corresponding voice signal that is also stored.

This initial formatting transcribes, for example, the level 0 text into aeronautical language (for example, similar to the information on published charts, METAR messages, etc.), taking into account acronyms, capital letters and commonly used shortcuts. For example, it indicates:
C for Charlie;
27L for twenty-seven left;
weather information: SCT for Scattered, BKN for Broken;
. . .

In one embodiment, the INTERP unit 22 then selects one or more processes to be performed on the level 0 text from among several types of processes (processing level No. i, i=1 to Nᵢᵥ) as a function of the associated note class and performs these one or more selected processes. Thus, some level 0 texts will not be subjected to subsequent level processing and others will be.

In one embodiment:

the first level or level 0 corresponds to the “raw” speech-to-text output without any formatting or interpretation;

level 1 corresponds to formatting of the previous level: aeronautical acronym (SCT for scattered), aeronautical alphabet (C for Charlie), Arabic numerals for numbers (1 for one), and/or text punctuation;

level 2 corresponds to an interpretation of the data from the previous level: type/value (parameter QNH=1012 for “QNH 1012”), command.

Considering the example where level 2 processing includes extraction involving interpreting some note data, this processing is only carried out for ATC and ATIS type notes. Additional data such as a summary and an English translation are also determined and added in embodiments of the invention for this level 2.

In a step 103, a note is generated by the GEST_NOTES unit 23 as a function of each level 1 text associated with its note class and with the corresponding level 2 text when it exists, and is stored in a memory (not shown). Each note is, for example, a function of the associated note type. The GEST_NOTES unit 23 creates the note so that it can be displayed as described hereafter (numbering of the notes, date of the note, content of the folded and unfolded forms of the note, etc.).

In a step 104, the note obtained at the output of the GEST_NOTES unit 23 is delivered in order to be displayed by the AFF unit 30. In one embodiment, the display is specific to the note class. The AFF unit 30 displays the notes (or at least some of them), for example, in real-time, in an HMI dedicated to the notes for the current flight. They also can be consulted at a later time.

Each note is numbered. Several numbering schemes can be contemplated: a single numbering scheme irrespective of the note type, or a numbering scheme per note type.

Each note is dated. Notes are classified according to time. The notes are presented in an order selected by the user (which can be modified at any time): from the oldest to the most recent, from the most recent to the oldest.

In another embodiment, the GEST_NOTES unit 23 adds an indication of the flight phase to the chronological sequence to make it easier to find a note. This flight phase information was obtained, for example, by the GEST_NOTES unit 23 from a cockpit avionics module (for example, Flight Management System).

The three types of note are thus differentiated in the HMI in the display unit 30. A note appears, in the list of consultable notes, once the voice signal issuing this note has ended (for example, in the next half minute).

For example, each note has two display forms: a folded form (summary, summarized, essential information only) and unfolded form. For example, the folded format varies according to the note type.

In one embodiment, the display is:
ATC type notes: folded and unfolded form: text level 2 and text level 1 presentation;
ATIS type notes: folded form: level 2 text; unfolded form: level 2 text and level 1 text;
Miscellaneous type notes: level 1 only.

It is possible to modify each note once it has been completed and is available in the list of notes, via the HMI in the display unit 30. The HMI then presents the selected note for modification in a specific format allowing modification.

It is possible to modify a note:
by selection, then manual modification (touch-sensitive interaction), irrespective of the note type; or
by selection, then voice modification, for example, only for “Miscellaneous” type notes.

It is possible to delete a note, with the option of retrieving it from a recycle bin if necessary.

The AFF display unit 30 therefore manages several display formats for the data of a given flight:
Nominal mode: notes displayed in folded form;
Selection mode: selected note displayed in unfolded form;
Edit mode: selected note displayed in edit mode;
“Deleted items” mode: displays deleted notes.

Optionally, a mode can be used to display only notes of a note type selected from among the three types (filtering function).

Optionally, a mode can be used to display only notes associated with a selected flight phase (when the note is associated with the flight phase, cf. above).

Switching from one mode to another is carried out by an action of the user (HMI interaction).

The AFF display unit 30 manages access to several note files. There is one file per flight containing the notes for the flight. Access to the file for a given flight allows the notes for the given flight to be viewed at a later date.

A new notes file is created at the start of each flight. At the end of a flight, the notes for this flight are therefore archived in the same file and can be consulted at a later date.

The creation of the notes file at the start of the flight and its archiving at the end of the flight are triggered by a manual command or automatically (for example, as a function of the state of the aircraft or the flight phase).

By way of an illustration:

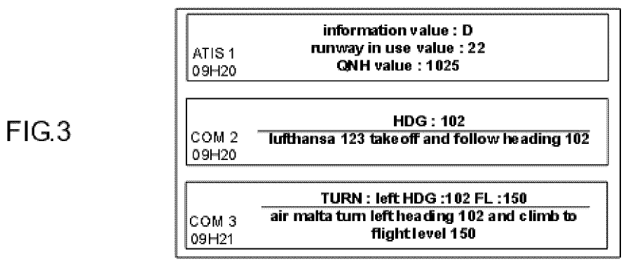

an example of an ATIS type note generated in one embodiment of the invention is shown in FIG. 3;

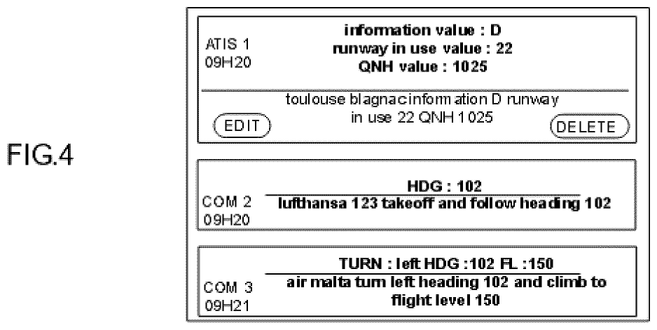

an example of an ATC type note generated in one embodiment of the invention is shown in FIG. 4;

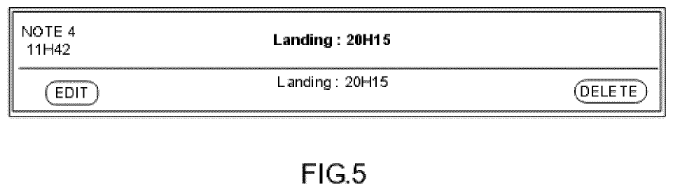

an example of a “Miscellaneous” type note generated in one embodiment of the invention is shown in FIG. 5.

The first note in FIG. 4, starting from the top, is in unfolded form; the other notes are in their non-unfolded form. In FIGS. 3, 4 and 5, the acronym ALT is used to indicate the altitude; the acronym HDG is used to indicate the heading; the acronym FL is used to indicate the flight level; the acronym QNH is used to characterize the atmospheric pressure; the acronym TURN is used to indicate the direction of rotation.

The pilot assistance device described above thus allows the voice to be intelligently transcribed (and annotated if necessary) on board an aircraft depending on the context. It reduces the workload of the pilot (or more generally of a crew member) in terms of their routine tasks; notably it:

makes it easier to take notes, whether or not the hands of the pilot are occupied;
restores the noted information, in a structured and clear manner.

Only three classes of voice signals have been considered herein. In other embodiments, N distinct classes are considered, with N being any integer greater than or equal to two, with specific note processing being implemented for each class. For example, a class corresponds to ATC exchanges from the control tower to the pilot, etc. A class is defined as a function of Human Machine Interface (HMI) and/or avionics type inputs.

The method can be implemented by executing software instructions on a processor, as described. Alternatively, it can be implemented by dedicated hardware, typically a digital integrated circuit, which is either specific (ASIC) or is based on programmable logic (for example, a Field Programmable Gate Array (FPGA)).

1. An aircraft piloting assistance method, comprising the following steps implemented by an electronic piloting assistance device:
detecting an event, with said event being an event for identifying a note class from among a set of predefined events for identifying N note classes, with N being an integer≥2;
for each class, for each event for identifying a note class: following said detecting step, triggering the acquisition of a voice signal currently being transmitted or received by the pilot and associated with said note class, and processing said acquired voice signal, with said processing being a function of the note class and comprising at least the conversion of the voice signal into text and the generation of a note as a function of the text;
detecting that an event for identifying a note class is a function of at least one element from among the following: detecting a keyword in a voice signal currently being transmitted or received by the pilot, detecting the manual or virtual activation of a Human Machine Interface element in the aircraft.

2. The aircraft piloting assistance method according to claim 1, wherein the signal to be acquired and processed is selected as a function of the note class identified by the detected identification event.

3. The aircraft piloting assistance method according to claim 1, comprising at least one of the following features:
i/ an identification event that has been predefined in order to identify the transmission of a voice signal by the pilot via their microphone to the control tower, with the acquisition and the processing following the detection of such an event in this case being selectively carried out on the voice signal transmitted by the pilot;
ii/ an identification event that has been predefined in order to identify the broadcasting of an ATIS recording in the aircraft to the pilot, with the acquisition and the processing following the detection of such an event in this case being selectively carried out on the voice signal received by the pilot;
iii/ an identification event that has been predefined in order to identify a voice note command triggered by the pilot, with the acquisition and the processing following the detection of such an event in this case being selectively carried out on the voice signal transmitted by the pilot.

4. The aircraft piloting assistance method according to claim 3, comprising at least one of the following provisions:
in the case of feature i: detecting the identification event comprises detecting the activation of the Push-To-Talk button by the pilot;
in the case of feature i or iii: detecting the identification event comprises detecting a keyword in a voice signal transmitted by the pilot or detecting the selection of a Human Machine Interface element by the pilot;
in the case of feature ii: detecting the identification event comprises detecting a keyword in a voice signal received by the pilot or detecting the selection of a Human Machine Interface element by the pilot.

5. The aircraft piloting assistance method according to claim 1, wherein said processing comprises one or more steps selected as a function of the type of note class from among the following: raw transcription of the voice signal, selective extraction of data from the text that relates to the flight parameters, determining a summary of the text.

6. A computer program, intended to be stored in the memory of an aircraft piloting assistance device and further comprising a microcomputer, said computer program comprising instructions which, when they are executed on the microcomputer, implement the steps of a method according to claim 1.

7. An aircraft piloting assistance device, said device being adapted for detecting an event, with said event being an event for identifying a note class from among a set of predefined events for identifying N note classes, with N being an integer≥2;
said device being further adapted, for each class, for each event for identifying a note class, following said detecting step, for triggering the acquisition of a voice signal currently being transmitted or received by the pilot and associated with said note class and for processing said acquired voice signal, with said processing being a function of the note class and comprising at least the conversion of the voice signal into text and the generation of a note as a function of the text;
for detecting that an event for identifying a note class is a function of at least one element from among the following: detecting a keyword in a voice signal currently being transmitted or received by the pilot, detecting the manual or virtual activation of a Human Machine Interface element in the aircraft.

8. The aircraft piloting assistance device according to claim 7, adapted for selecting the signal to be acquired and processed as a function of the note class identified by the detected identification event.
